(19) United States
(12) Patent Application Publication
(10) Pub. No.: US 2007/0045974 A1
(43) Pub. Date: Mar. 1, 2007

(54) WHEELED CAN FOR BAR REFUSE

(76) Inventor: Roger L. Young, Augusta, MO (US)

Correspondence Address: CHARLES C. MCCLOSKEY, 763 S. NEW BALLAS ROAD STE. 170, ST. LOUIS, MO, 63141, US

(21) Appl. No.: 11/466,593

(22) Filed: Aug. 23, 2006

Related U.S. Application Data
(60) Provisional application No. 60/710,978, filed on Aug. 24, 2005.

(51) Int. Cl. B62B 1/00

(52) U.S. Cl. 280/47.26

(57) ABSTRACT

A wheeled can fits within the width and depth at the end of a bar. The can has a generally hollow container with an open top and a closed bottom. The top has a width and a depth to fit within a narrow and limited opening at the end of a bar. The can has two reinforcing ribs and at least one handle. The can tapers downwards for its length on both the width and the depth of the container. The bottom is generally narrower than the top. Near the bottom, two corners are recessed and curved to accept a wheel and include a slot for an axle. In use, the wheels fit within the width and depth established by the top and within the front and the back at the bottom. The wheels allow staff to remove the wheeled can from a confined space readily.

### CROSS-REFERENCE TO RELATED APPLICATION

This is a non-provisional application claiming priority to the provisional application with a serial No. of 60/710,978 which was filed on Aug. 24, 2005 and is commonly owned by the same inventor.

### BACKGROUND OF THE INVENTION

The wheeled can relates generally to a refuse container, and more specifically, one that fits within the confined space of a bar or other establishment. The wheeled can may be blow molded, or injection molded, from a polymer. A unique aspect of the present invention is wheels upon an axle that fit within the footprint of the top of the wheeled can. The wheeled can has attributes that allow for its swift assembly, from a minimum of parts, but yet have substantial reinforcement that lengthens the useful life in a demanding environment.

As a day draws to a close, people emerge from workplaces and homes across the land for in search of refreshment. The search often takes people to a restaurant, bar, or other establishment. Bars serve alcohol in various drinks and the alcohol is packaged in a variety of containers. As people consume drinks, bottles, cans, and other containers accumulate around a bar as empties. Bartenders, waiters, and other staff pick up, collect, and dispose of the empties. The empties are generally collected in a container at a single location, commonly at the end of a bar. The location has tight space requirements as a bar calls for maximum length available to serve people. When the container fills, a bartender, generally junior, takes the container outside to a dumpster and unloads the empties from the container into the dumpster. When moving the full container, the container endures abuse and gets dragged along the ground.

Obviously, many refuse containers are available upon the market, and have been for a good number of years. Many of these are molded from polymer either as injection or blow molded. These containers have various types of lids that attach to them, and lock in place, and are reasonably sturdy. In those instances where the containers may be blow molded, the containers are generally fabricated of a thinner polymer material, and tend to wear out relatively fast, along their pressure points, as at the bottom, when the heavily laden containers are drug over the surface, to a location for either storage or disposal. There are even refuse containers that include means to facilitate their movement, such as through the application of wheels, at the bottom, which somewhat lessens the degree to which the containers wear out, at least through abrasion, as previously used.

### DESCRIPTION OF THE PRIOR ART

The present art overcomes the limitations of the prior art. That is, the art of the present invention allows a wheeled can to nest during shipment and to fit within a confined space at the end of a bar. Refuse containers generally have a large volume but light weight. When shipping refuse containers from the manufacturer to a distributor or establishment, multiple containers are nested together to save on shipping costs due to volume. When nested, multiple refuse containers occupy a minimal volume. Nesting requires a few compromises in container design generally tapering each container and having an establishment or end user install the wheels or other accessories at the final location of the container. The present invention meets these compromises by including handles in the container design and allowing for ready snap fitting of an axle into the container base.

The difficulty in designing a container for nesting and a small space is shown by the operation of a typical device, particularly that device of the inventor now U.S. Pat. No. 6,769,702. This patented container has a tapered body for receiving refuse with slightly rounded corners. Handles and wheel structures attach to the container body by fastening onto a boss formed with the container. The bosses are recessed upon the container body and fit within the taper. Each boss has a reinforcing section behind the boss towards the interior of the container. The bosses and reinforcing sections are formed into mold that makes the container. The mold thus has more recesses and intricacies raising the cost of the mold.

Further, the wheel structure of this patent supports the separate wheels and axle and then secures to a boss upon the container. The wheel structure and its fastener are separate from the container and require separate manufacturing. The wheel structure, wheels, and axle are then installed upon the container and secured by a fastener upon the boss. The wheels of this patented invention extend outwards of the taper and the width of the container thus inhibiting nesting of a wheeled container.

### SUMMARY OF THE INVENTION

Generally, the present invention provides a wheeled can that accepts bar refuse and the wheels fit within the footprint of the can. The can has a generally hollow body with an open top and a closed bottom. The top has a width and a depth to fit within a narrow and limited depth opening at the end of a bar. Near the top, the can has two reinforcing ribs integral to the body. At least one handle extends from a lower rib on the width or lateral side of the can. The can tapers downwards for its length on both the width and the depth of the body. The bottom is generally narrower in width and depth than the top. Proximate to the bottom, two corners of the body are recessed inwards and curved to accept a wheel. The corners are shaped to include a slot that accepts an axle. In use, the wheels are placed at the ends of the axle and then the axle is pressed into the slot with the wheels turning upon the axle and within the recess. The wheels fit within the width and depth at the bottom and established by the tapering of the sides, front, and back of the container. Fitting within those dimensions, the wheels allow staff at a bar to remove the can from a confined space readily.

There has thus been outlined, rather broadly, the more important features of the invention in order that the detailed description thereof that follows may be better understood and that the present contribution to the art may be better appreciated.

Further, the present invention also includes a generally trapezoidal shape, handles extending outwards from a rib, a raised panel in the bottom of the body, and reinforcement of the corners of the body.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

It is, therefore, the principal object of this invention to provide a wheeled can for bar refuse that can be fabricated from a minimum of components, all molded from a polymer, preferably by blow molding, and yet assembled in two or three steps by the end user to complete the fabrication of the entire container thus making it ready for usage as a refuse container.

Another object of this invention is to provide a wheeled can, including the wheels, that fits within the narrow limits at the end of a bar for a refuse container.

Another object of this invention is to provide a wheeled can for bar refuse that may be fully fabricated and injection or blow molded in a single operation.

Another object of this invention is to provide for a wheeled can for bar refuse, that may be blow molded from a minimum of polymer material, and therefore, is very lightweight, but yet significantly sturdy and strong of structure, to provide it with a sustained useful life.

Still another object of this invention is provide a wheeled can for bar refuse that may be very easily moved during usage by a worker, even though it may be laden with significantly bulk or heavy waste or other material.

Lastly, it is an object to provide a wheeled can for bar refuse that can be easily and efficiently manufactured and marketed to equipment distributors and bar or establishment operators.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows a side view of the preferred embodiment of the wheeled can without wheels constructed in accordance with the principles of the present invention;

FIG. 2 illustrates a detailed view of the recess on the container;

FIG. 3 shows a detailed view of the grip upon the first stiffener;

FIG. 4 describes a detailed view of the axle snapped into the slot upon the bottom of the body including wheels of the present invention;

FIG. 5 shows a front view of the present invention with wheels and handles in use;

FIG. 6 shows a side view of the present invention and particularly showing the wheels tucked within the side and front tapers, and the bottom of the container;

FIG. 7 illustrates a detailed view of the handles upon the present invention;

FIG. 8 shows a side view of an alternate embodiment of the wheeled can for two axles;

FIG. 9 illustrates a front view of the alternate embodiment;

FIG. 10 describes a bottom view of the alternate embodiment for two axles;

FIG. 11 shows a bottom view with two axles installed in the alternate embodiment; and,

FIG. 12 describes the alternate embodiment in a side view with wheels and axles installed.

The same reference numerals refer to the same parts throughout the various figures.

### DESCRIPTION OF THE PREFERRED EMBODIMENT

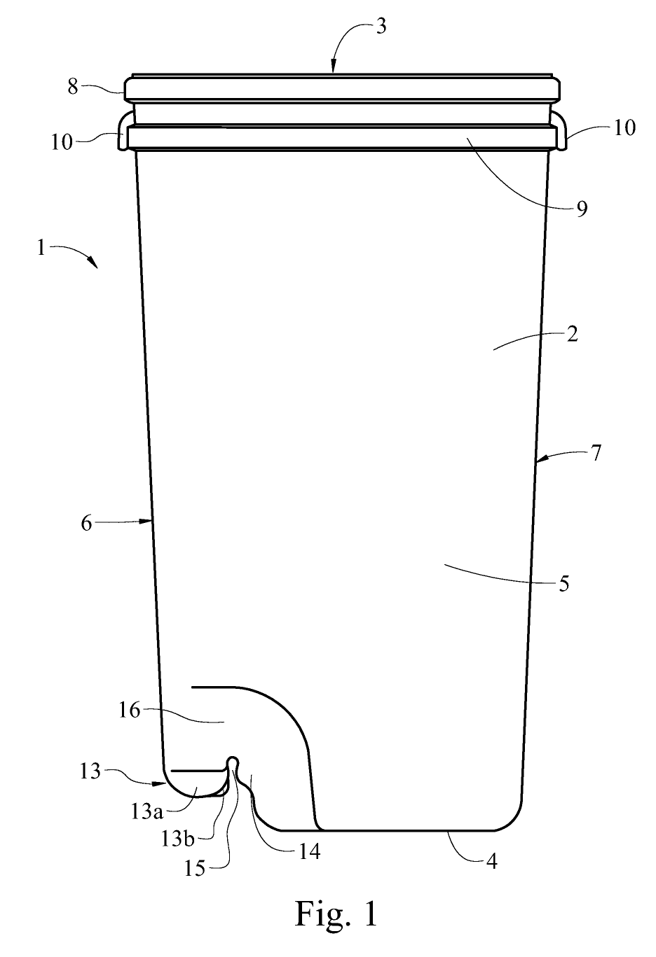

The present art overcomes the prior art limitations by having two ribs at the opening and positioning the axle closer to the center of the bottom of the can. In FIG. 1, the wheeled can 1 begins with a container 2 having an open top 3 and an opposite closed bottom 4 joined by four walls, the front 6 and opposite back 7, and two sidewalls 5. The top has a width and a depth to fit within the gap at the end of a bar. Generally the top is approximately 11 inches wide and 19 inches deep. The bottom is narrower in width and depth than the top. The width and depth of the container taper between the top and the bottom. Proximate to the top, the container has a first rib 8 on the exterior that occupies the perimeter of the container. In the preferred embodiment, the first rib 8 is approximately ¾ inch in height. Mutually parallel and spaced below the first rib 8, a second rib 9 occupies the perimeter. Where the second rib occupies the front 6 and the back 7, the second rib 9 has a handle 10 on each of the front and the back. The handles 10 extend outward from the second rib so that a worker may grasp the container, tip it, and move it.

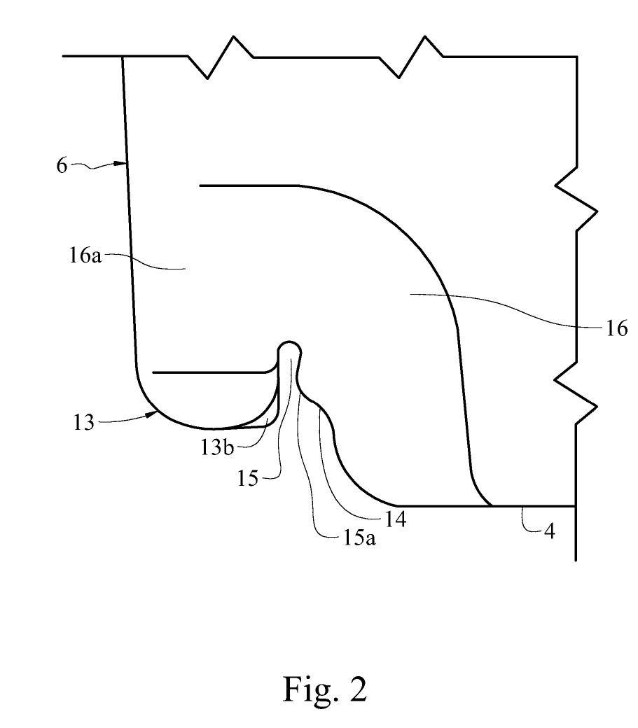

The back 7 extends from the top to the bottom for the full height of the wheeled can 1. Preferably the back is 32 inches tall which meets shipping requirements and typical gaps at the ends of bars. Opposite the back, the front extends downwards from the top partially towards the bottom. Opposite the top but above the bottom, the front 6 has the first stiffener 13 spanning across the width of the can. The first stiffener 13 has a somewhat cylindrical shape that is thickened more so than the can. At each end, proximate to the sides, the first stiffener has a miter 13a that narrows the length of the first stiffener as it approaches the bottom. In the center, the first stiffener has a grip 13b later shown in FIG. 2.

The bottom 4, opposite the top 3, has a narrower width and depth than the top due to tapering. The bottom has a shallower depth as the bottom rises up towards the front 6. Where the bottom 4 rises, it has the second stiffener 14. The second stiffener has a ridge like or minor cylindrical shape extending across the width of the bottom. The second stiffener has a smaller diameter than the first stiffener as it protrudes from the bottom away from the center of the can. Between the first stiffener and the second stiffener, the bottom has a slot 15 across its width. The slot 15 has a hollow round shape with a diameter to receive an axle 12 snapped into the slot 15.

Both sides have a generally trapezoidal shape with the wider base as the top 3 and the narrower base as the bottom 4. The sides 5 have a recess 16 towards the front 6. The recess 16 is generally a quarter circle area where the width of the container is narrowed by generally two thicknesses of the wheels 11, later shown in more detail in FIG. 2. The recess 16 allows a wheel 11 to turn but remain completely within the tapering of the sides 5 and the front 6. Further, the slot 15 is positioned inwards from the front by approximately the radius of a wheel.

The recess 16 appears in more detail in FIG. 2. Each side 5 of the container 2 has a recess generally located at the intersection of the front 6 and the bottom 4. The recess extends into a side to accommodate the entire area of a wheel 11 within the side 5. The recess extends into the front to accommodate the entire thickness of a wheel 11 within the tapering of the front 6. The recess has a generally quarter circle shape innermost into the side with two perpendicular tangential lines extending from the quarter circle shape. Inset from the plane of the side, the recess has a flat surface 16a to permit turning of a wheel. The flat surface 16a is generally parallel to the side 5 of the container 2. Opposite the quarter circular edge, the recess comes upwards from the bottom. The recess moves upwards inwards from the front slightly over the radius of a wheel. In moving upward, the recess curves towards the second stiffener 14. The second stiffener extends towards the front and forms a neck 15a slightly beneath the slot 15. The slot 15 is above the second stiffener 14 and has a diameter to admit the axle 12 snugly. Opposite the second stiffener and beneath the slot, the recess continues with the first stiffener 13. Generally in the center, the first stiffener 13 has a grip 13b with a rounded corner to the depth of the first stiffener. The grip 13b assists bar staff in grasping the first stiffener 13 when the wheeled can 1 is up ended to unload the waste contents within the wheeled can. Flanking the grip, the first stiffener has two mitered ends 13a. The mitered ends extend from the grip 13b and widen outwards towards the recess 16, particularly the flat surface. The first stiffener 13 is generally curved as it extends from the neck 15a of the slot 15 around to the front of the wheeled can.

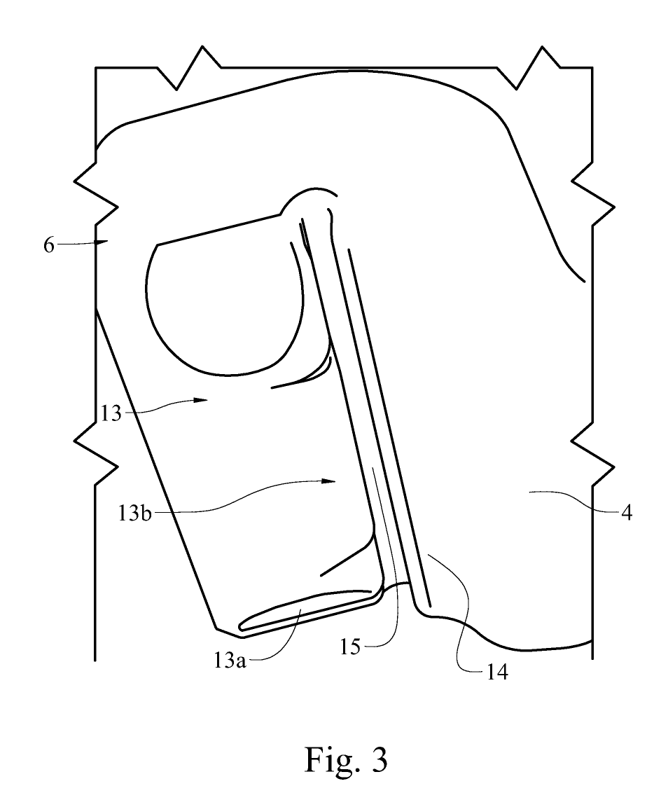

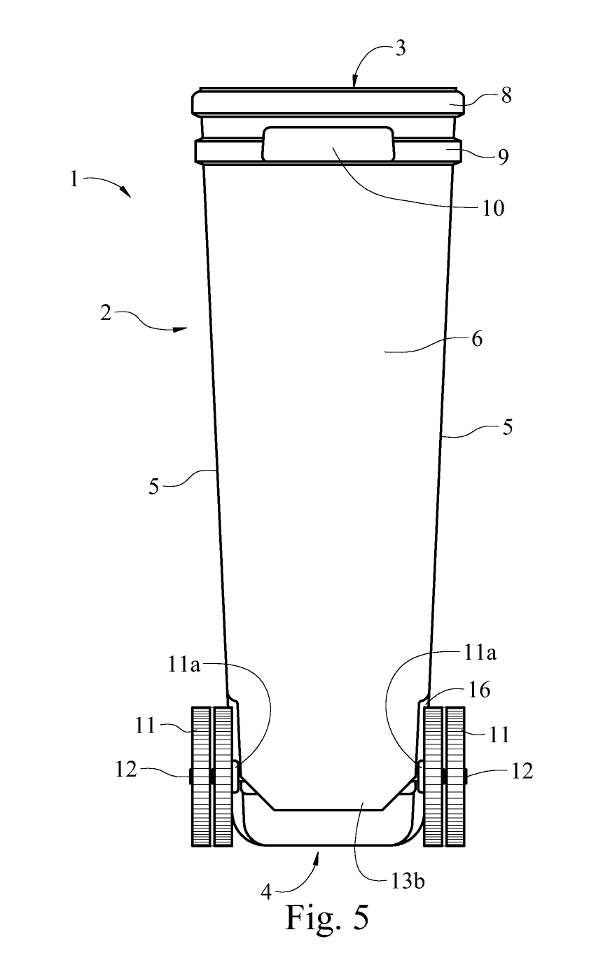

FIG. 3 shows the slot and first stiffener in more detail. The slot extends between the recesses 16 of both sides 5 of the wheeled can. The second stiffener and the first stiffener form a neck 15a of less width than the diameter of the slot and slightly below the slot. Opposite the second stiffener, the first stiffener 13 has a generally cylindrical shape with the ends 13a mitered at approximately forty five degrees as also later shown in FIG. 5. The mitered ends narrow the width of the first stiffener towards the bottom 4 of the wheeled can. The mitered ends 13a improve the appearance of the wheeled can and aid in blow molding of the container. Within the mitered ends, the first stiffener has the grip 13b extending towards the slot. The grip 13b is formed from a plane tangential to the first stiffener at its lowest point that reaches towards the slot 15. The grip provides a place for the hand of a bar staff member to grasp the wheeled can when unloading it.

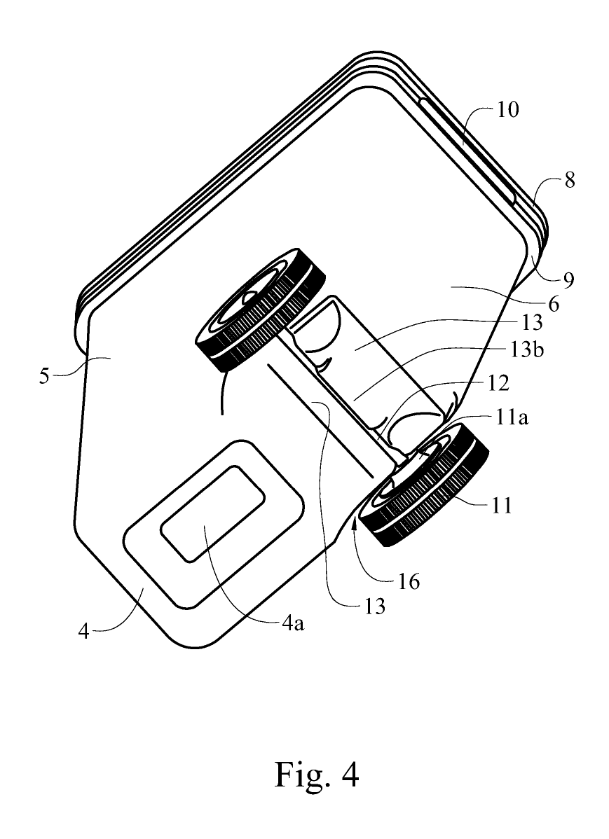

The wheels 11 are located near the bottom 4 and near the front 6 as shown in FIG. 4. An axle 12 is snapped through the neck 15a and into the slot 15 formed within the first stiffener 13 and the second stiffener 14. The axle spans across the width of the front and beyond both sides. Two spacers 11a and then two wheels 11 are then placed upon each end of the axle and secured, preferably with pale nuts. The wheels rotate upon the axle and within the recess. Away from the second stiffener, the bottom 4 has a raised panel 4a that extends towards the interior of the container. The raised panel 4a adds rigidity to the bottom 4 when loaded and reduces the surface area of the bottom subject to wear when the container is moved to and from a bar. Here the raised panel 4a is shown similar to a rectangular vault.

Turning FIG. 1 with wheels installed upon the container reveals FIG. 5. The wheels 11 are located within the recesses 16 on the sides 5 near the bottom 4. In an alternate embodiment, each wheel 11 has a spacer 11a installed between the wheel and the container. The spacer 11a minimizes the surface area of the wheel that wears on the container and prevents the wheel from tipping towards the container. In the preferred embodiment between the wheels, the front 6 descends to the first stiffener 13 that reaches below the axle 12. The first stiffener has mitered ends 13a with a centered grip 13b. In this view, the wheels fit within the width of the wheeled can established by the width of the top.

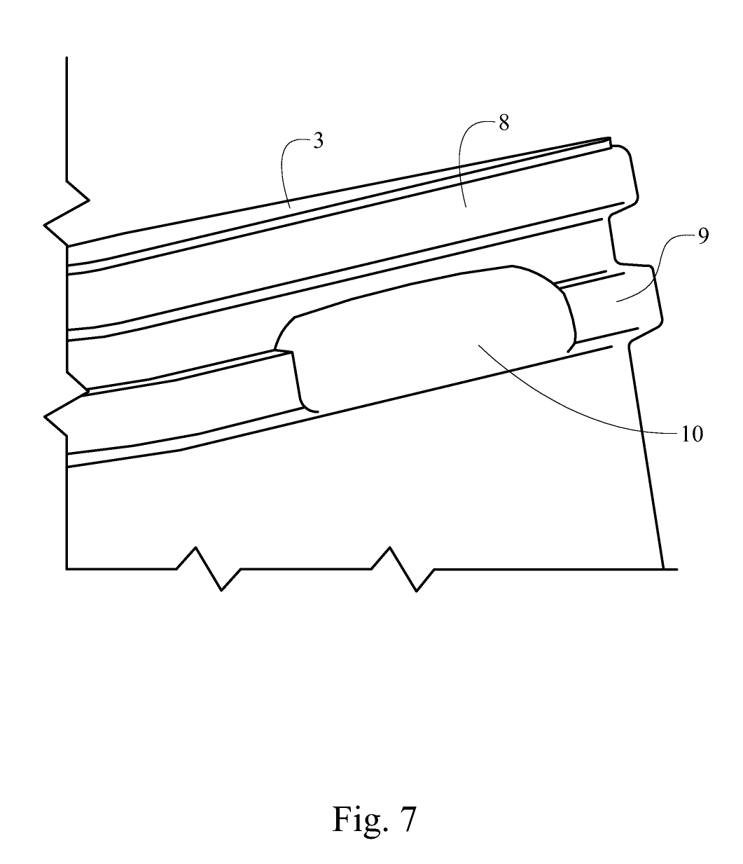

Above the wheels, the second rib has a handle 10 on both the front and the back. The handle 10 extends outward from the can and partially along the width of the front. Each handle 10 has a rounded trapezoidal shape as later shown in FIG. 7 with the narrower base towards the top of the container. In the preferred embodiment, the handles 10 are hollow with a gap between the handle 10 and the second rib 9. In use, a worker loads the can and then moves the can by grasping the handle and tipping the container upon the wheels, generally towards the worker. A worker then lifts the can by grasping the grip and a handle or grasping both grips. The wheeled can is then unloaded into a dumpster or other large waster removal container by turning upon front or the back, or completely upside down.

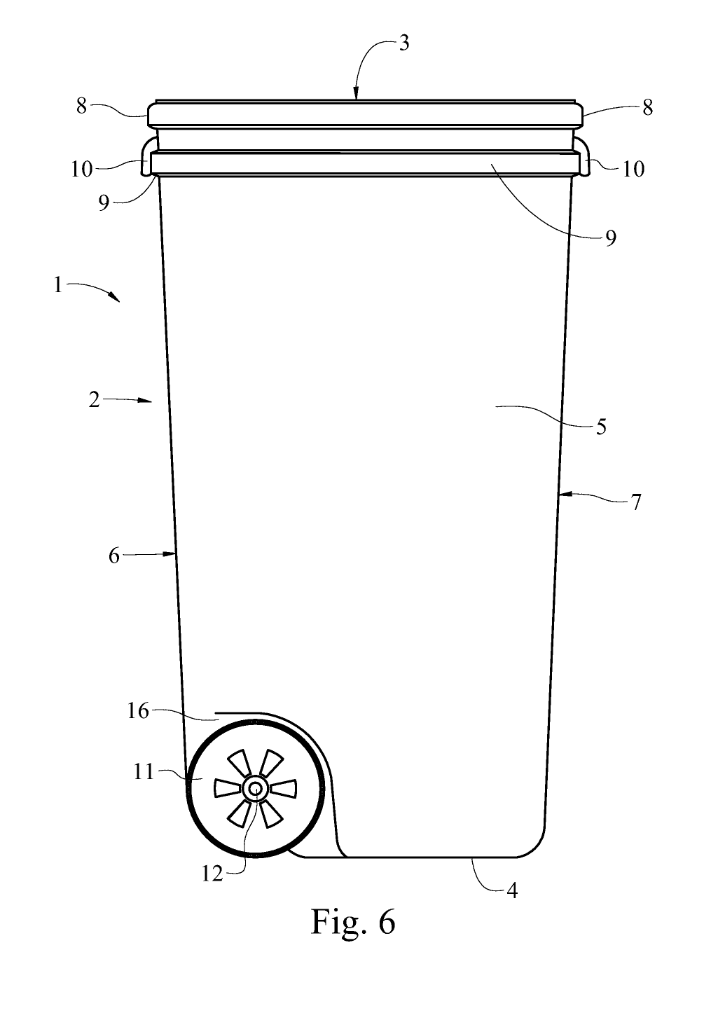

Viewing the other side, FIG. 6 shows a handle located on the second rib 9 on the back 7 which is opposite the handle 10 located on the front 6. The handle on the back allows a worker to grasp both the front and the back of the can for maneuvering and when dumping the can. FIG. 6 also shows how a wheel fits within the recess 16 on a side 5 thus maintaining a clean profile of the can. The edge of each wheel 11 is located within the tapering of the front and the back and proximate to the bottom.

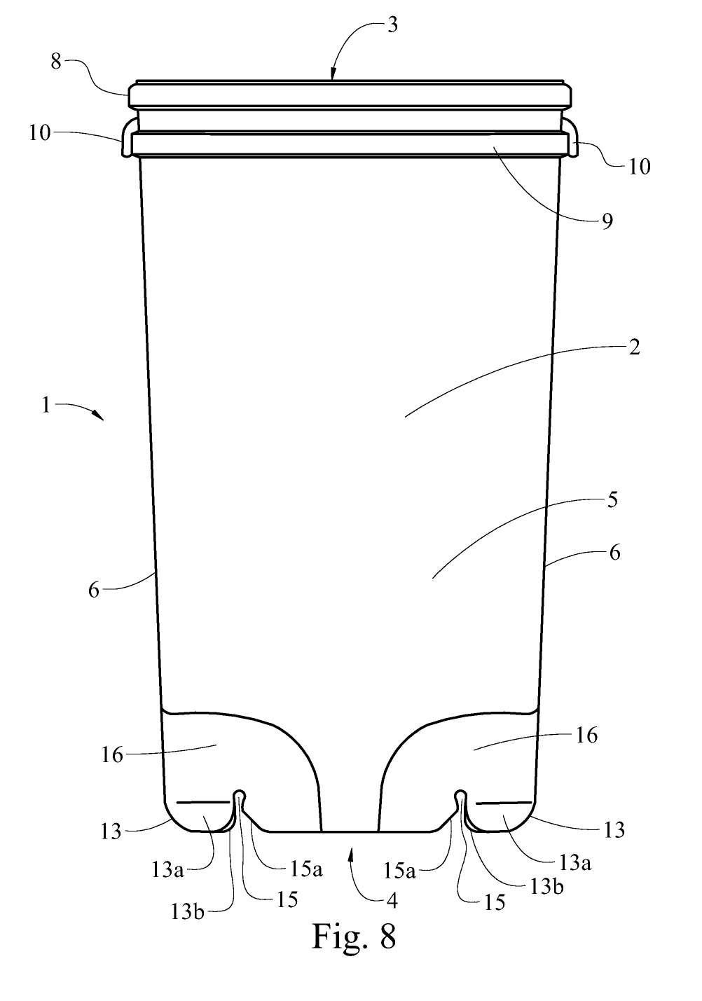

An alternate embodiment of the present invention having two wheels takes form in FIG. 8. As before, the alternate embodiment of the wheeled can 1 has a container 2 having an open top 3 and an opposite closed bottom 4 joined by four walls, two opposite fronts 6 and two sidewalls 5 perpendicular to the fronts. The top fits within the gap at the end of a bar, generally 11 inches wide and 19 inches deep. The bottom is narrower in width and depth than the top. The width and depth of the container taper from the top to the bottom. Proximate to the top, the container has the first rib 8 upon the perimeter of the container and the first rib 8 is approximately ¾ inch in height. The second rib is mutually parallel and spaced below the first rib 8. Where the second rib occupies each front 6 in the alternate embodiment, it has a handle 10 generally centered. The handles extend outward from the second rib so that a worker may grasp the container, tip it, and move it from either end.

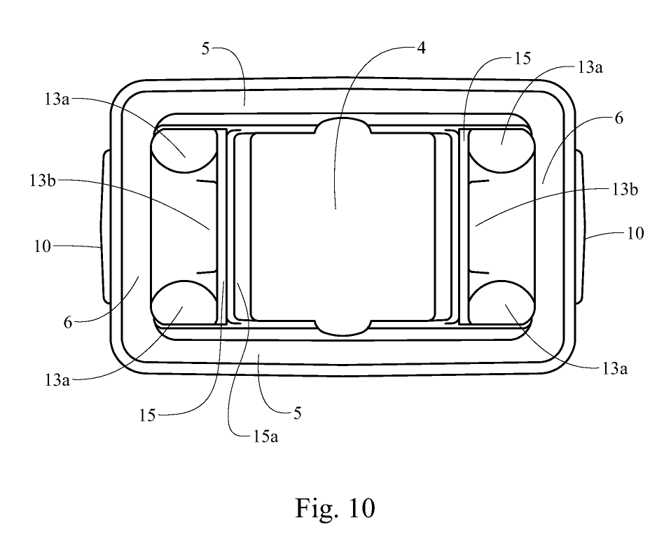

The fronts 6 extend from the top to the bottom for the full height of the wheeled can 1 unlike the preferred embodiment. Preferably the fronts are both 32 inches tall which meets shipping requirements and typical gaps at the ends of bars. The fronts extend downwards from the top proximate to the bottom 4. Slightly above the bottom, each front has a first stiffener 13 spanning across the width of the can. The first stiffener 13 has a somewhat cylindrical shape that is thickened more so than the can. At each end, proximate to the sides, the first stiffener has a miter 13a that narrows the length of the first stiffener as it approaches the bottom 4. In the center, the first stiffener has a grip 13b later shown in FIG. 10.

The bottom 4, opposite the top 3, has a narrower width and depth than the top due to tapering. The bottom has a shallower depth as the bottom rises up towards the front 6. Where the bottom 4 rises, it may have a second stiffener as in the preferred embodiment. Inwards from the first stiffener and the grip 13b, the bottom has two parallel and spaced apart slots 15 across its width. The slots 15 have a hollow round shape with a diameter to receive an axle 12 placed therein. The axle remains in place when inside the neck 15a of each slot.

Both sides have a generally trapezoidal shape with the wider base as the top 3 and the narrower base as the bottom 4. The sides 5 have a recess 16 at the intersection with the fronts 6 and proximate the bottom 4. Each recess 16 is generally a quarter circle area where the width of the container is narrowed by generally two thicknesses of the wheels 11, as previously shown in more detail in FIG. 2. Each recess 16 allows a wheel 11 to turn but remain completely within the tapering of the sides 5 and the front 6. Further, the slot 15 is positioned inwards from the front by approximately the radius of a wheel.

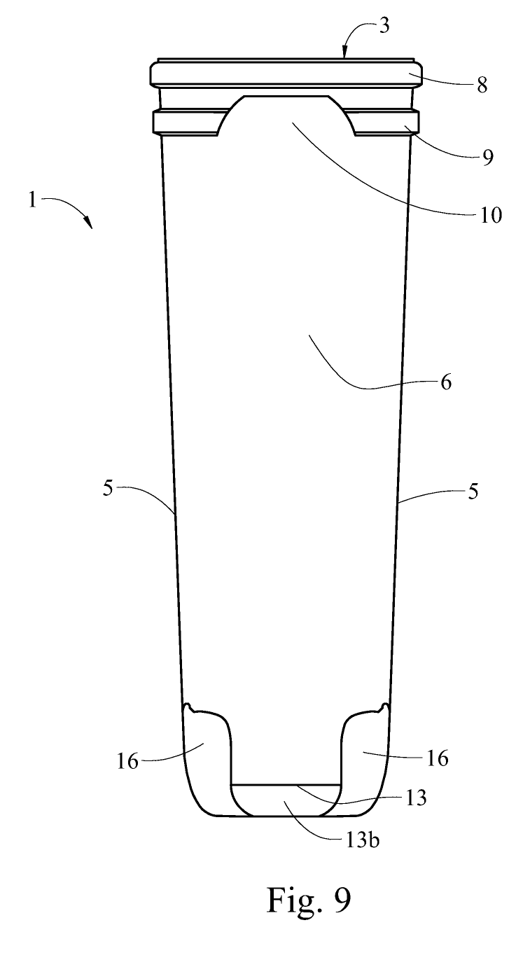

Turning the alternate embodiment, FIG. 9 shows a front of the container. As the container is symmetric the description of the front applies to both fronts 6. As before, the container 2 has a top 3 of a defined width and length. Beneath the top, the container has two parallel and spaced apart ribs 8, 9. The second, or lower, rib 9 has a handle 10 generally centered upon the front 6. The handle is a somewhat trapezoidal shape that extends out from the front so a worker can grasp the handle. The front then tapers downwards as both sides 5 come inwards in the vicinity of the bottom 4. As the front approaches the bottom 4. The front narrows by approximately one wheel thickness and forms two spaced apart recesses 16. As previously described, the recesses allow a wheel to remain within the taper of the sides and the fronts of the container thus the wheel fits within the defined shape of the top. Near the bottom, each front 6 has the first stiffener 13 that extends across the width of the narrowed front within the recesses. The first stiffener has a slight thickening of material as it curves in a generally quarter circle towards the bottom. Where the first stiffener 13 approaches the plane of the bottom, it has a grip 13b. The grip 13b is proximate the slot and aids in retaining an axle 12 within the slot.

Again turning the container shows the bottom view in FIG. 10. The bottom 4 is flanked towards the fronts 6 with spaced apart and mutually parallel slots 15 for axles. Each slot is formed between a neck 15a and the grip 13b. The grip 13b on each side extends from the first stiffener 13 that has mitered faces 13a toward each side 5. Each mitered face expands outwardly to join the plane of the side 5. The sides 5 extend upwardly and outwardly from the bottom 4 and the mitered faces 13a to the second rib with its handles 10. The bottom 4 and the lowest point of the first stiffener 13 are generally coplanar.

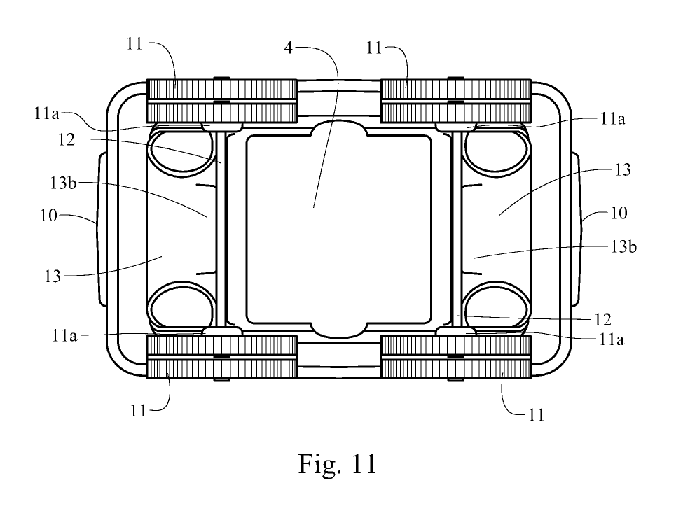

To allow movement of the alternate embodiment in either a forward or a rearward direction, wheels 11 are located near the bottom 4 and near the fronts 6 as shown in FIG. 11. An axle 12 is snapped through each neck 15a and into each slot 15 formed within the first stiffener 13. Each axle spans across the width of the front and slightly beyond both sides. Two spacers 11a and then two wheels 11 are then placed upon each end of each axle and secured, preferably with pale nuts. The wheels rotate upon the axle and within the recesses. The wheels on the two axles permit a worker to move the alternate embodiment in two directions, thus assisting in flexibility during usage.

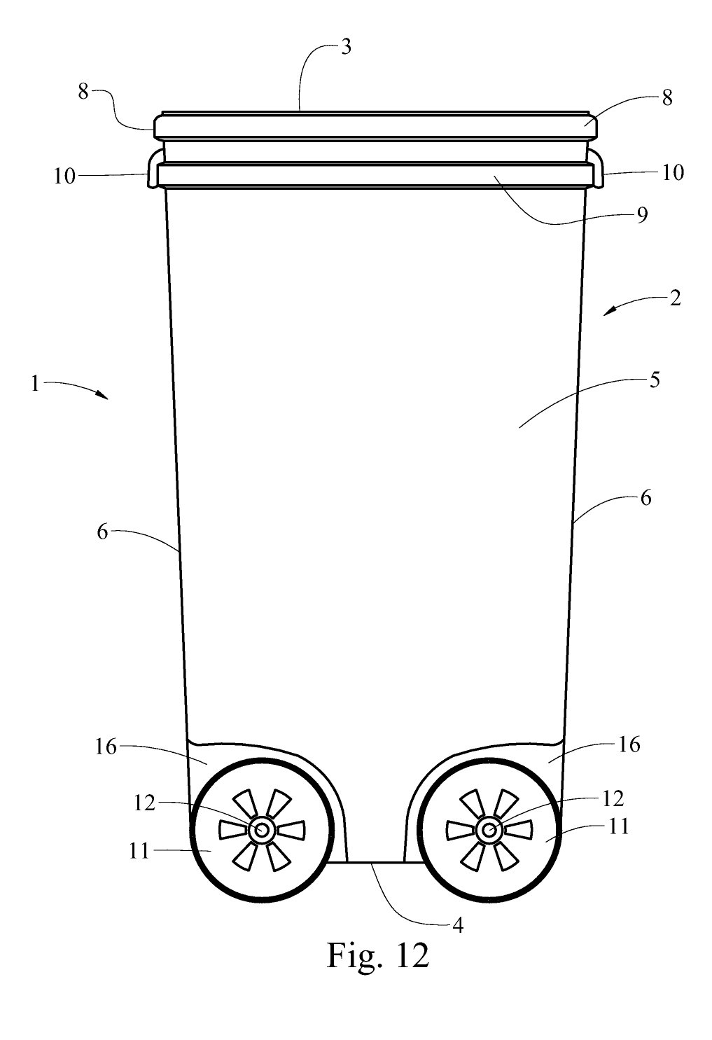

Between the axles 12, the bottom 4 has a raised panel that extends towards the interior of the container. The raised panel 4a adds rigidity to the bottom 4 when loaded. As before, the raised panel 4a is shown similar to a rectangular vault. The bottom 4, along with the container, is raised by the wheels in FIG. 12. The alternate embodiment has four wheels upon two axles and the placement of the axles within the neck 15a along with the diameter of the wheels lifts the container upwards from the floor surface during usage. A raised bottom 4 encounters less dragging and abrasion during usage and thus the container lasts longer. As previously described, the wheels fit within the recesses 16 so the tapering of the sides and the fronts continues. The alternate embodiment meets the dimensional and durability requirements of rugged usage in a bar or other establishment environment.

The preferred embodiment uses polymer material for forming a container of at least 0.03 inch thickness and a generally hollow rectangular cross section along the length of the can. From the aforementioned description, a wheeled can for bar refuse has been described. The wheeled can is uniquely capable of fitting within the confined space at the end of a bar and extending the life of the bottom of the can by using wheels upon an axle. The wheeled hub and its various components may be manufactured from many materials including but not limited to polymers, plastics, ferrous and non-ferrous metals and their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A wheeled container that collects refuse from the end of a bar or other beverage serving location, comprising:
a container having an open top and an opposite closed bottom, two spaced apart sides, each tapering in depth from said top to said bottom, a front and an opposite back, each tapering in width from said top to said bottom, wherein said container fits within a narrow location;
a first rib outwards from said container and located upon the perimeter of said top;
a second rib, mutually parallel and spaced beneath said first rib;
at least one handle in said container; and,
at least two wheels rotating upon at least one axle located proximate to said front and to said bottom, said wheels being located inside the perimeter of said container established by said top and being located inside the width of said front at said bottom and said back at said bottom.

2. The wheeled container of claim 1 further comprising:
a first stiffener located in said front proximate to said bottom, extending across the width of said front;
a second stiffener located in said bottom proximate to said front, extending across the width of said bottom; and,
a slot formed between said first stiffener and said second stiffener, said slot receiving said axle.

3. The wheeled container of claim 2 wherein said first stiffener has a generally cylindrical shape joined longitudinally to said container and said second stiffener has a generally ridge like shape extending outwards from said bottom parallel to said first stiffener.

4. The wheeled container of claim 3 wherein said slot has a circular bottom approximately the same diameter as said axle.

5. The wheeled container of claim 1 further comprising:
each of said sides having a recess near the intersection of said front and said bottom, each of said recesses having a partial convex shape towards the interior of said container and a diameter to admit one of said wheels.

6. The wheeled container of claim 4 wherein said recesses have a generally quarter circle shape.

7. The wheeled container of claim 1 further comprising: said bottom having a raised panel.

8. The wheeled container of claim 5 further comprising:
at least two spacers, each spacer located upon said axle and between one of said wheels and one of said recesses.

9. The wheeled container of claim 5 further comprising:
each of said sides having another of said recesses locating near the intersection of said back and said bottom;
two axles, mutually parallel and spaced apart on said bottom proximate to said front and said back; and,
four wheels, in pairs upon each of said axles, said wheels fitting within said recesses.

10. A wheeled container that collects refuse from the end of a bar or other beverage serving location, comprising:
a container having an open top and an opposite closed bottom, two spaced apart sides, each tapering in depth from said top to said bottom, two spaced apart fronts, each tapering in width from said top to said bottom, and each perpendicular to said sides, wherein said container fits within a narrow location;
a first rib outwards from said container and located upon the perimeter of said top;
a second rib, mutually parallel and spaced beneath said first rib;
at least one handle in said container; and,
at least four wheels rotating upon at least two axles located proximate to said fronts and to said bottom, said wheels being located inside the dimensions of said container established by said top and being located inside the width of said front at said bottom and said back at said bottom.

11. The wheeled container of claim 10 further comprising:
a first stiffener located in each of said fronts proximate to said bottom, extending across the width of said front;
and,
a slot forming between said first stiffener and said bottom for receiving said axle, having a circular bottom approximately the same diameter as said axle.

12. The wheeled container of claim 11 wherein said first stiffener has a generally cylindrical shape across said bottom.

13. The wheeled container of claim 11 each of said sides having a recess near the intersections of said fronts and said bottom, said recesses having a partial convex shape towards the interior of said container and a diameter to admit a portion of one of said wheels.

14. The wheeled container of claim 13 wherein said recesses have a generally quarter circle shape.

15. The wheeled container of claim 10 further comprising:
at least four spacers, each spacer locating upon said axle and between one of said wheels and one of said recesses.
